(19) United States
(12) Patent Application Publication
(10) Pub. No.: US 2023/0302931 A1
(43) Pub. Date: Sep. 28, 2023

(54) OFFSHORE ELECTRICAL CHARGING SYSTEM WITH INTEGRATED FLYWHEELS

(71) Applicant: Spinning Reserve, LLC, Cut Off, LA (US)

(72) Inventor: Jan Mikalsen, Covington, LA (US)

(21) Appl. No.: 18/126,378

(22) Filed: Mar. 24, 2023

Related U.S. Application Data
(60) Provisional application No. 63/323,482, filed on Mar. 24, 2022.

(51) Int. Cl. B63B 22/00; B60L 53/52; B60L 53/51; B60L 53/18; B60L 53/56; B60L 53/30; B60L 53/60

(52) U.S. Cl. CPC B60L 53/30; B60L 53/18; B60L 53/51; B60L 53/52; B60L 53/56; B60L 53/60; B63B 22/00; B63B 2035/4453

(57) ABSTRACT

An offshore electrical charging system and process may include a marine vessel. Multiple flywheels may be stored on the marine vessel. An electrical power network or system may be positioned on the marine vessel, and be electrically connected to the flywheels. An electrical connector may be in electrical communication with the electrical power network to enable electrical power from the flywheels to flow via the electrical connector to supply power from the marine vessel. At least one power switch may be disposed on the electrical power network, and be configured to enable electricity to flow between the electrical connector and flywheels. A controller may be configured to control the at least one power switch to enable and disable electrical power to flow between the flywheels and the electrical connector via the electrical power network.

### RELATED APPLICATIONS

This Application claims priority to co-pending U.S. Provisional Patent Application having Serial No. 63/323,482 filed on Mar. 24, 2022; the contents of which are incorporated herein by reference in their entirety.

### BACKGROUND OF THE INVENTION

Marine vessels have used a variety of different power sources. Most marine vessels have used diesel engines for powering electrical systems of the marine vessels. However, diesel engines are inefficient, expensive to operate, and produce undesirable emissions. In most cases, marine vessels that are parked offshore use diesel power to maintain the marine vessels in a stationary position as well as powering the electrical and electronic equipment of the marine vessels. It is not uncommon for active shipping ports, such as those in Singapore, to have several hundred marine vessels parked offshore while waiting for dock space, and such idling is very expensive and produces extremely high emissions.

Consequently, marine vessels have begun using rechargeable batteries. Rechargeable batteries, however, are expensive and tend to have limited range and are time consuming to recharge. Moreover, rechargeable batteries have a limited lifespan and include hazardous waste materials that result in dangerous pollution when discarded. Another limiting factor of rechargeable batteries is that heat that can damage the batteries or other electrical equipment used to support the rechargeable batteries. As such, there is a need for a power source that does not produce high emissions, is less expensive to operate, has a long lifespan, does not result in pollution when discarded, and is less affected by elevated temperatures, is able to be recharged faster with lower risk of a catastrophic event, and includes rare Earth minerals that are more readily available than those used for rechargeable batteries.

### BRIEF SUMMARY

To overcome the problems and limitations of diesel engines and rechargeable batteries, flywheels configured to generate sufficient power to operate marine vessels may be utilized. Flywheels have virtually limitless speed of recharging. As such, it is possible to recharge flywheels, even large ones (e.g., 1 MW flywheels), much faster than rechargeable batteries. For example, it may take several hours to recharge a large rechargeable battery (e.g., 1 MWh), but fewer than 10 minutes to recharge a comparable charged flywheel. Flywheels are also kinetic energy storage devices that may be used for vessel stabilization purposes on marine vessels. In one proposed usage, flywheels may also be used for electronically powering marine vessels as the flywheels are particularly efficient and maintain electrical charge in the form of kinetic energy for long periods of time. Moreover, flywheels produce no emissions, do not include hazardous waste, and are low cost to operate.

In the case of marine vessels having rechargeable batteries, the rechargeable batteries are typically recharged using power lines from shore. In some cases, offshore platforms or offshore charging buoys, which typically receive electrical power from shore, may be used to provide electricity to marine vessels that are parked offshore. If those marine vessels use diesel generators, the diesel generators can be turned OFF and power from the offshore platforms or charging buoys may be used to maintain the electrical powered systems on the marine vessel. The offshore charging buoys may be configured to generate electricity, but may also be used as a junction or switch to conduct electricity between conduits (e.g., from a marine vessel power station with flywheels as energy sources to other marine vessels). If the marine vessels have rechargeable batteries, then those batteries may be recharged by the offshore power sources. However, as previously described, the time to recharge the rechargeable batteries can be extensive, such as 6 hours or more, which is costly and inefficient for operations of marine vessels, especially as compared to flywheels that may be fully charged in minutes.

One embodiment of an offshore electrical charging system may include a marine vessel. Multiple flywheels may be stored on the marine vessel. An electrical power network or system may be positioned on the marine vessel, and be electrically connected to the flywheels. An electrical connector may be in electrical communication with the electrical power network to enable electrical power from the flywheels to flow via the electrical connector to supply power from the marine vessel. At least one power switch may be disposed on the electrical power network, and be configured to enable electricity to flow between the electrical connector and flywheels. A controller may be configured to control the at least one power switch to enable and disable electrical power to flow between the flywheels and the electrical connector via the electrical power network.

### BRIEF DESCRIPTION OF THE FIGURES

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is an illustration of an illustrative barge on which an electrical power system inclusive of flywheels for use in storing kinetic energy when charged and distributing electrical energy therefrom;

FIG. 2 is an illustration of an illustrative marine vessel on which an electrical power system inclusive of flywheels for use in storing kinetic energy and distributing electrical energy therefrom;

FIG. 3 is an illustration of an illustrative barge on which an electrical power system inclusive of flywheels for use in storing kinetic energy and distributing electrical energy therefrom;

FIG. 4 is an illustration of an illustrative set of barges on which an electrical power system inclusive of flywheels for use in storing kinetic energy and distributing electrical energy therefrom;

FIG. 5 is an illustration of an illustrative portion of a marine vessel on which an electrical power system inclusive of flywheels for use in storing kinetic energy and distributing electrical energy therefrom;

FIG. 6 is an illustration of an illustrative charging buoy that may be connected to (i) an electrical power system, such as on a marine vessel, as an electrical power supply source via a first electrical conductor and (ii) a second electrical conductor in electrical connection with the first electrical conductor and another marine vessel for recovering electrical power to electrically power electrical equipment or to recharge rechargeable batteries thereon, for example;

FIG. 7 is an illustration of an illustrative charging buoy that may be connected to an electrical power system, such as on a marine platform, inclusive of flywheels via an electrical conductor and include multiple electrical conductors that may be simultaneously connected to marine vessels or other systems that use electrical power to power electrical equipment or to recharge rechargeable batteries thereon;

FIG. 8 is an illustration of a set of illustrative charging buoys that may be connected (i) to electrical power systems, such as positioned on marine platforms, barges, vessels, or otherwise, inclusive of flywheels via respective electrical conductors and (ii) to other electrical conductors that may be simultaneously connected to multiple marine vessels and/or other systems that use electrical power to power electrical equipment or to recharge rechargeable batteries thereon;

FIG. 9 is an illustration of an illustrative charging buoy that may be connected to an electrical power system, such as on a marine platform, subsea generator, land generator, inclusive of flywheels via an electrical conductor and include multiple electrical conductors that may be simultaneously connected to marine vessels or other systems that use electrical power to power electrical equipment or to recharge rechargeable batteries thereon;

FIG. 10 is an illustration of an illustrative charging station inclusive of an electrical power system with integrated flywheels that may be connected to offshore windmill(s) to maintain energy in the flywheels, where the charging station may include electrical conductor(s) to charge or power marine vessels, including flywheels or rechargeable batteries on the marine vessels, thereby providing an “all green” power solution;

FIG. 11 is an illustration of an illustrative autonomous power station barge inclusive of an electrical power system with integrated flywheels that may be electrically connected to a marine vessel with a flywheel to charge the flywheel within 10 minutes, for example; and

FIG. 12 is an illustration of an illustrative autonomous power station barge inclusive of an electrical power system with integrated flywheels that may be electrically connected to a charging buoy for supplying electrical power to one or more marine vessels with flywheel(s) to charge the flywheel(s) within 10 minutes, for example.

### DETAILED DESCRIPTION OF THE INVENTION

To provide for an offshore supply of electrical power, including electrical power used (i) to power electrical equipment on a marine vessel, (ii) charge rechargeable batteries, and/or (iii) supply electrical power to islands or waterfront areas, a flywheel power station barge, power station marine vessel, or other offshore platform, including a large number of flywheels (e.g., from dozens to several hundred) capable of storing a large amount of electrical power (e.g., kilo-Watt hours (kWh) or mega-Watt hours (MWh)) may be utilized. The flywheels may be integrated into an electrical power system that is used to electrically power a marine vessel or other marine system that utilizes electrical power.

An offshore platform that produces electrical power through use of a variety of clean energy sources, such as solar, wind, and/or wave energy may be used to recharge the flywheels on the offshore platform. One or more charging buoys may be electrically connected to the offshore platform so as to provide an offshore charging station. The offshore platform and/or charging buoys may be anchored and marine vessels may connect to respective power lines extending from the charging buoys while free-floating and dynamically parked in a substantially fixed position (e.g., remain within a few feet while parked, but be capable of rotating to face the bow of the marine vessel into the wind).

Because the marine vessel is capable of moving back and forth to shore, multiple marine vessels with flywheels operating thereon may be intermittently swapped as the flywheels lose electrical power, naturally and through supply consumption. That is, as the flywheels on a power station marine vessel begins running low on power, that marine vessel may be disconnected from power line(s) that are connected to the charging buoy(s) and another marine vessel with charged flywheels may connect to the power lines to supply power to other marine vessels via the charging buoy(s). In an embodiment, the charging buoy(s) may include or be electrically connected to batteries or temporary power supplies that may provide for continuous or uninterrupted power during a swap of the vessels with the flywheels. Alternatively, the charging buoy(s) may be configured with parallel power lines such that two electrical charging systems with flywheels on different marine vessels (e.g., barges) may be simultaneously connected so as to avoid interruption of power during a transition from one electrical charging system (e.g., power station barge) to another electrical charging system (e.g., power station barge).

In some cases, the flywheels lose only 2% of kinetic energy or electrical power potential over a 24-hour period, thereby enabling the marine vessel with multiple flywheels to have sufficient charge to power other marine vessels, islands, or other land masses, for a long period of time. For example, if a marine vessel carrying 400 flywheels each having 4 MW hours (MWh) of capacity, 1600 MWh of total capacity may be available. Alternative configurations of flywheels on a marine vessel may be available.

To make the flywheel recharging process marine-friendly, a recharging buoy may be electrically connected to the marine vessel with the flywheels (e.g., barge power station) and be remotely positioned (e.g., floating) from the marine vessel so as to avoid physical contact. In an embodiment, multiple recharging buoys may be electrically connected in series or in parallel to a power network on the marine vessel so that electrical power output from the flywheels may be distributed to recharge rechargeable batteries or flywheels positioned on other marine vessels receive power from the recharging buoys. The recharging buoys may be configured with electrical equipment to enable large amounts of electrical power to flow between a source electrical conductor and a load electrical conductor. The electrical equipment may be passive or active to operate as a common power bus or include electrical switches to activate and deactivate electrical paths. Moreover, the recharging buoys may include smart meters to record electrical power supply and consumption along with identities of both supplier and consumer of the electrical power.

An electrical power grid may be established on or off the marine vessel serving as a power station to supply power to the recharging buoys. In such a configuration, a controller may be used to selectively supply power from the flywheels in a strategic manner, such as supplying power from one or more of the flywheels at a time so as to maximize power distribution.

Smart power meters electrically connected to the electrical power grid (e.g., on the marine vessel(s) and/or on the recharging buoys) may be used to monitor an amount of power distributed from the marine vessel. Timers may be used to time how long other vessels are connected to receive power from the marine vessel. It should be understood that a variety of different power charging business models may be utilized in providing customers, such as other marine vessel customers, electrical energy from the electrical power systems with the flywheels functioning as electrical energy sources. The smart power meters may communicate via a satellite communications network to a remote server configured as a billing system to provide billing data.

In an embodiment, a system may receive information about marine vessels connecting to the recharging buoys so as to be used to track power consumption by the recharging marine vessels. The recharging costs may be measured based on time connected to the recharging station, amount of power transferred, and/or otherwise, and an accounting system may be configured to automatically invoice or draw funds from an account, such as a prepaid account, of owners of the marine vessels that receive power for electrical system use (e.g., to avoid operating on diesel-generated electrical power) or recharging rechargeable batteries and/or flywheels.

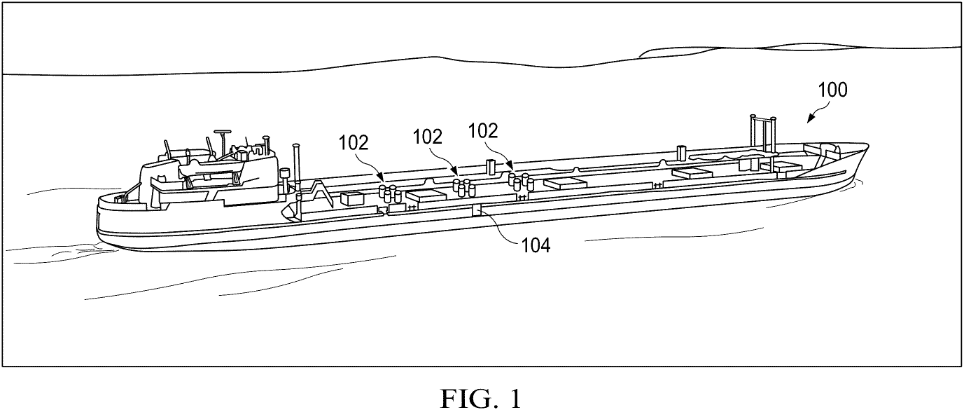

With regard to FIG. 1, an illustration of an illustrative marine vessel or barge 100 on which an electrical power system inclusive of flywheels 102 for use in storing kinetic energy and distributing electrical energy or power therefrom is shown. The flywheels 102 may be mounted to the deck and/or below deck, thereby enabling the barge 100 to serve both as a conventional barge for moving cargo and functioning as a power station. In an embodiment, the barge 100 may be configured as just a power station (i.e., no space to transport cargo). This type of barge 100 may be powered and be configured to store many flywheels 102 onboard that are connected to an electrical power system inclusive of input and output electrical ports 104 for receiving power to recharge the flywheels 102 by causing rotors of the flywheels to increase spin rates to maximize kinetic energy. Alternatively, the barge 100 may be a passive barge and be pushed or pulled using towboats and include the electrical power system, as previously described.

Depending on the size of the barge 100, upwards of 300 or more flywheels 102 may be positioned on the barge and be used for storing kinetic energy and delivering electrical power . Because the flywheels 102 may be charged fast (e.g., within 10 minutes) and store significant kinetic energy than may be utilized to output electrical power (e.g., 1 MWh per flywheel), the ability to charge some or all of the flywheels on the barge may be performed very fast (e.g., 10 minutes with parallel charging to a few hours for sequentially charging groups of flywheels depending on the electrical power grid). In addition, energy from the onboard flywheels 102 may be used to power electrical thrust system(s) used to propel the barge 100 or maintain the barge 100 in a stationary or parked position.

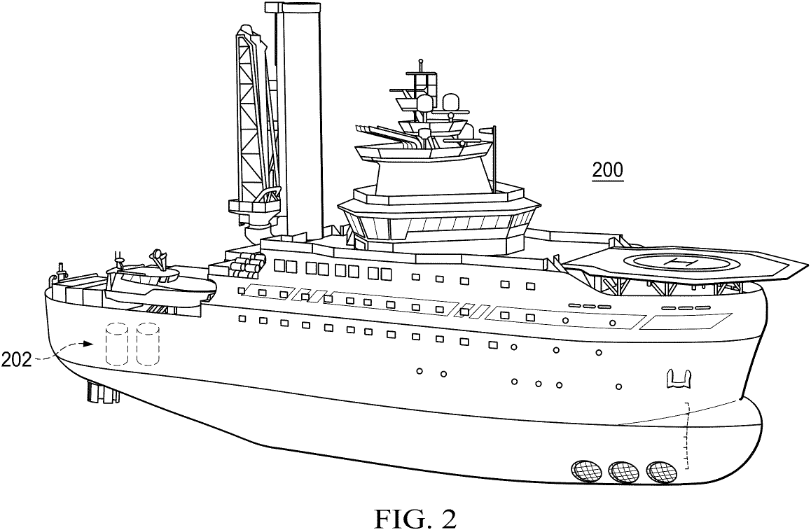

With regard to FIG. 2, an illustration of an illustrative marine vessel 200 on which an electrical power system inclusive of flywheels 202 for use in storing kinetic energy and distributing electrical power therefrom is shown. This marine vessel 200 may use the onboard flywheels to power electrical equipment on the marine vessel and electrical thrusters used to propel the marine vessel 200. An electrical system (not shown) may be utilized to charge the flywheels 202 from an onboard or off-board power system and to enable the flywheels 202 to supply electrical power to the onboard or an off-board electrical power system.

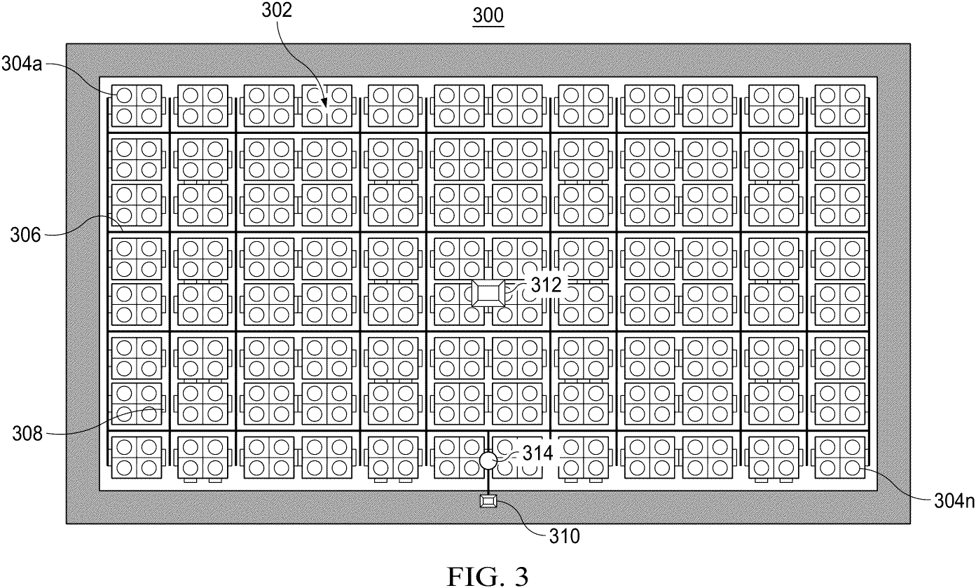

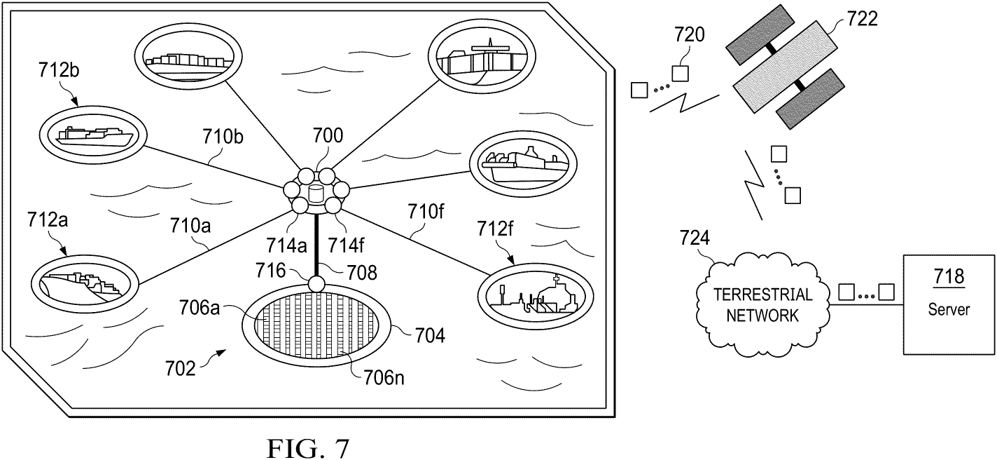

With regard to FIG. 3, an illustration of an illustrative barge 300 on which an electrical power system 302 inclusive of flywheels 304 for use in storing kinetic energy and distributing electrical power therefrom is shown. The barge 300 is a passive barge and may contain one or more electrical power systems configured with many flywheels 304 to supply power to other marine vessels or on-shore power systems directly or indirectly (e.g., via a charging station or charging buoy). As shown, the electrical power system or power network 302 may include flywheels 304 (generally operated in pairs), electrical conductors 306, and electrical switches 308 along the conductors 306 of the electrical power system 302 that enables an operator to switch electrical power ON and OFF from being conducted to or from one or more of the flywheels 304, thereby controlling recharging of and sourcing from the flywheels 304 on the electrical power system 302. A computing system (see FIGS. 3 and 7) may be used to control operation of the switches 308 and flywheels 304 on the electrical power system 302. A smart metering system (see FIG. 7) including electrical meters (e.g., smart meters) may be configured to monitor amount of time, electrical power, or otherwise that is transferred to and from the electrical power system 302 and/or individual flywheels 304. A computing system may interface with the smart meters to track customers of the electrical power system 302 and generate information for billing of the customers, where the customers may be marine vessels, land customers, marine platforms, or otherwise.

As further shown, an electrical connector 310 may be in electrical communication with one or more of the electrical conductors 306 to enable another electrical connector (not shown) of an electrical conductor (not shown) that connects directly to another marine vessel, for example, a charging buoy, or any other power distributor. The electrical conductors 306 and switches 308 may be configured as an electrical network, such as an electrical grid, and a controller 312 may be configured to control the switches 308 to cause electrical power to be output by the flywheels 304 and onto the electrical network to flow to the electrical connector 310 to supply power from the barge 300. The controller 312 may be configure to cause electrical power to flow from the flywheels 304 to the electrical power network without disrupting available electrical power being supplied by the electrical power network. In an embodiment, the controller 312 ensures that another set of flywheels are connected prior to disengaging power from the connector 310.

In an embodiment, a smart meter 314 may be configured to measure electrical power drawn from the connector 310, time of power draw by another electrical power system (e.g., on a marine vessel), and identifier of the other electrical power system. The collected data by the smart meter 314 may be communicated to a system, such as a server (see, for example, FIG. 7), for processing and invoicing thereby. Alternative devices and processes for performing manual, semi-automatic, and automatic data collection and invoicing may be utilized, as well. In an embodiment, a timer on smart meter 314 or elsewhere may be utilized to time a duration of power draw by the other electrical power system, and that time may be used as part of an invoice as part of or in addition to the power draw. Moreover, rather than simply measuring time of power draw, an amount of time that the other electrical power system is connected to the electrical connector 310 may be collected and treated as a separate charge or part of the charge of the electrical draw.

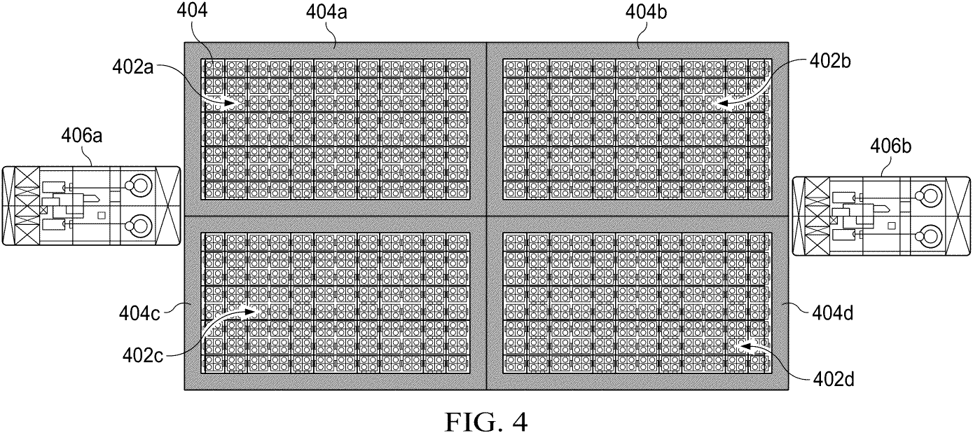

With regard to FIG. 4, an illustration of an illustrative set of barges 400a-400d (collectively 400) on which respective electrical power systems 402a-402d (collectively 402) inclusive of flywheels 404 for use in storing kinetic energy and distributing electrical power therefrom is shown. Towboats 406a and 406b may be utilized to propel the barges 400. By connecting multiple barges 400 together, in this case four barges, with the electrical power systems 402 with integrated flywheels, the ability to provide electrical power to other electrical power systems or electrical grids on an island, for example, in large quantities and for relatively long durations may be possible. A control system on the electrical power systems may be used to meter the electrical energy output from the flywheels 404 .

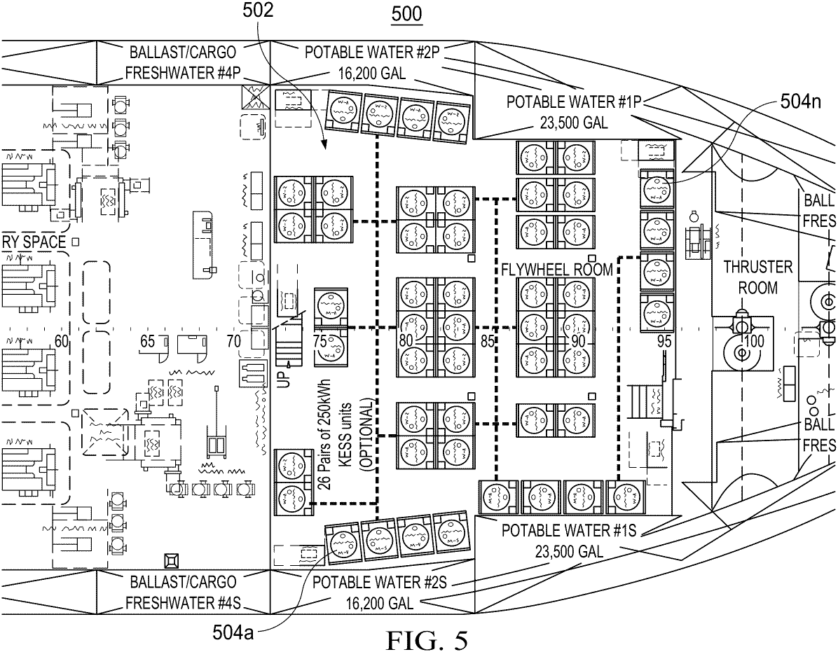

With regard to FIG. 5, an illustration of an illustrative portion of a marine vessel 500 on which an electrical power system 502 inclusive of flywheels 504a-504n (collectively 504) for use in storing kinetic energy and distributing electrical power therefrom is shown. In this case, only a portion of the marine vessel 500 may include the flywheels 504. For example, 26 pairs of flywheels 504 that are capable of outputting 13,000 kWh (i.e., 500 kWh each), for example, may be disposed on the marine vessel 500. The flywheels 504 are often formed and operate in pairs. The flywheels 504 may be stored below deck, thereby providing for protection against environmental conditions, such as salt, water, humidity, sun, and other environmental conditions. Because the flywheels 504 generate little heat and noise, the crew of the marine vessel 500 may be less sensitive to flywheel energy than diesel engine energy because diesel engine energy tends to produce low frequency noise and vibrations throughout the marine vessel 500.

In an embodiment, diesel gensets (generator sets) may be used to charge the onboard flywheels 504 for short periods of time and then the flywheels, may operate for long periods of time, thereby consuming lower amounts of fuel usage than alternative sources of primary power generation (e.g., diesel engine). Such a hybrid system (e.g., diesel engine -flywheels) may provide for reduction in maintenance, improve operational gains, provide faster response, result in reduced noise and emissions, enable longer service intervals of engines, and increase safety. These and other reasons for use of a hybrid marine vessel power system inclusive of flywheels may support the reasons for use of such a system. Moreover, to the extent that additional flywheel electrical power exists than is consumed by the marine vessel, such electrical power may be available to be supplied to other marine vessels from the flywheels 504 via the electrical power system 502, as further described herein.

TABLE I below provides an example of marine vessel operation verses electrical power usage. Such a chart may be useful in providing a designer with the ability to scope out an amount of needed electrical power and an operator with operational specifications for performing various tasks, such as transport distances, stationary operations, and so on. Moreover, there may be other reasons for use of electrical power consumed by the marine vessel.

TABLE I

Example Marine Vessel Operational Use and Total Electrical Power Usage

| N.M | Speed knots | kWh | Houers to sail | Total kWh used |
|---|---|---|---|---|
| 8 | 5 | 850 | 1,6 | 1360 |
| 16 | 12 | 1350 | 1,3 | 1800 |
| | | | | 3160 |
| 8 | 5 | 850 | 1,6 | 1360 |
| 22 | 12 | 1350 | 1,8 | 2475 |
| | | | | 3835 |
| 8 | 5 | 850 | 1,6 | 1360 |
| 25 | 12 | 1350 | 2,1 | 2813 |
| | | | | 4173 |
| 88 | 12 | 1350 | 7,3 | 9900 |

As another example, a 26 pair flywheel that delivers 13,000 kWh may provide the following metrics.

| | | |
|---|---|---|
| Hour on DP with gangway | (13,000 kWh) | 11.3 Hours |
| Hour on DP | (13,000 kWh) | 15.5 Hours |
| Hour on Transit 5 knots | (13,000 kWh) | 15.5 Hours |
| Hour on Transit 12 knots | (13,000 kWh) | 9.5 Hours |
| Hour on Auto Sail between turbines | (13,000 kWh) | 13.5 Hours |

Moreover, TABLE II shows illustrative power and transit marine vessel operations by the 26 pairs of flywheels. DP is dynamic positioning using a marine vessel propulsion control system to manage and control electrical thrusters for controlling dynamic positioning of the marine vessel.

TABLE II

Power and Transit Marine Vessel Operations

| | Load DP/Transit kWh | Hotel load kWh | Gangway kWh | Total kWh |
|---|---|---|---|---|
| Average kW on DP with gangway | 500 | 350 | 300 | 115 |
| Average kW on DP | 500 | 350 | | 850 |
| Average kW in Transit the first 7 miles 5 knots | 500 | 350 | | 850 |
| Average kW in Transit the first 27 miles 12 knots | 1000 | 350 | | 1350 |
| Average kW in Auto Sail between turbines 10 knots | 6000 | 350 | | 950 |

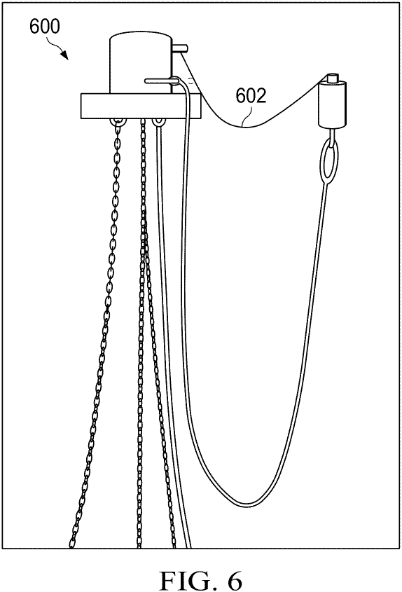

With regard to FIG. 6, an illustration of an illustrative charging buoy 600 that may be connected to an electrical power system, such as on a marine vessel, via a first electrical conductor 602 and include a second electrical conductor (not shown) in electrical connection with the first electrical conductor 602 and configured to be in electrical connection with another marine vessel for powering electrical equipment or recharging rechargeable batteries/flywheels thereon, for example, is shown. The charging buoy 600 may be connected to an electrical power system integrated with flywheels on a marine vessel (e.g., barge serving as a floating power station), as further shown herein, to assist with supplying power to other marine vessels, marine platforms, land power grids, or otherwise. Using the charging buoy 600, the marine vessel with the flywheels (e.g., barge 300 of FIG. 3) may more easily enable other marine vessels to access power being supplied by the flywheels rather than having to connect directly to the electrical power system of the marine vessel. It should be understood that charging buoy 600 may alternatively be in electrical communication with other charging buoys to operate as a network as charging buoys, thereby enabling more marine vessels to access the power from the marine vessel serving as a floating power station using flywheels as the source of electrical power.

With regard to FIG. 7, an illustration of an illustrative charging buoy 700 that may be connected to an electrical power generation system 702, such as on a marine platform 704, inclusive of flywheels 706a-706n (collectively 706) via an electrical conductor 708 and be electrically connected to multiple electrical conductors 710a-710f (collectively 710) that may be simultaneously connected in parallel to marine vessels and/or other systems 712a-712f (collectively 712) that use electrical power for supplying electrical power to electrical systems (e.g., ship control systems, radar systems, electrical propulsion systems, etc.) and/or recharging rechargeable batteries thereon is shown. The marine platform 704 may be stationary on a platform, moored, or moveable so that the flywheels 706 stored thereon may be recharged with kinetic energy. In an embodiment, a diesel or other electrical power generation system may be used to recharge the flywheels 706. Alternatively, “green energy” electrical power generators, such as solar panels or wind turbines, may be used to recharge the flywheels 706. Combinations of power systems may alternatively be positioned on or electrically connected to the electrical power system 702 to recharge the flywheels 706. Still yet, electrical power from a land-based electrical power generator may be electrically connected to the electrical power system 702 as a backup to “green energy” electrical generators.

As further shown, multiple smart meters 714a-714f (collectively 714) may be disposed at the charging buoy 700. The smart meters 714 may be configured to measure electrical power usage by respective marine vessels and/or other systems 712 when connected to and receiving electrical power from the respective electrical conductors 710. In addition to the smart meters 714, a smart meter 716 may be positioned at the marine platform 704 and be configured to measure electrical power drawn therethrough from the flywheels 706 by the marine vessels and/or other systems 712. The smart meters 714 and/or 716 may be configured to measure and collect various parameters, including electrical power usage, amount of time the marine vessels and/or other systems 712 are drawing electrical power from the charging buoy 700, identifiers of the marine vessels and/or other systems 712, and so on such that a remote server 718 may process the data for billing owners or operators of the marine vessels and/or other systems 712 or other purpose. As shown, the smart meters 714 may be configured to communicate measured and/or collected data and communicate that data 720 via a satellite 722 for relay via a terrestrial network 724, such as the Internet, to the server 718 for processing. The identifiers of the marine vessels and/or other systems 712 may be collected in a number of ways, such as wirelessly (e.g., remotely sensed or communicated from the marine vessels and/or other systems 712 prior to the electrical power being turned ON), manually (e.g., entered into the respective smart meter), or otherwise.

The server 718 may further be configured to provide management functionality for the marine platform 704 and flywheels 706 either independently or in conjunction with a monitoring system (not shown), such as a local controller, on the marine platform 704. The management functionality may include monitoring charge status of each of the flywheels 706. As the kinetic energy and, consequently, potential electrical power, of the flywheels 706 depletes naturally or through supplying power to another electrical system, the server 718 may be configured to monitor and identify the change and current status of the flywheels 706. Prediction software may be utilized to predict an amount of time remaining for each of or a collective number of the flywheels 706. The server 718 may provide a notification to an operator of an estimated time that a new marine platform (e.g., power station barge) is needed to replace the existing marine platform 704 so that electrical power supply is not disrupted. Alternatively, rather than sending a new marine platform with flywheels, a charging system may be sent to the marine platform 704 to recharge the flywheels. Alternative ways of charging the flywheels 706 may be utilized. The estimation of remaining time may be dependent on a number of factors, including, but not limited to, scheduling of marine vessels or other systems that are to be powered by the flywheels 706 of the marine platform 704.

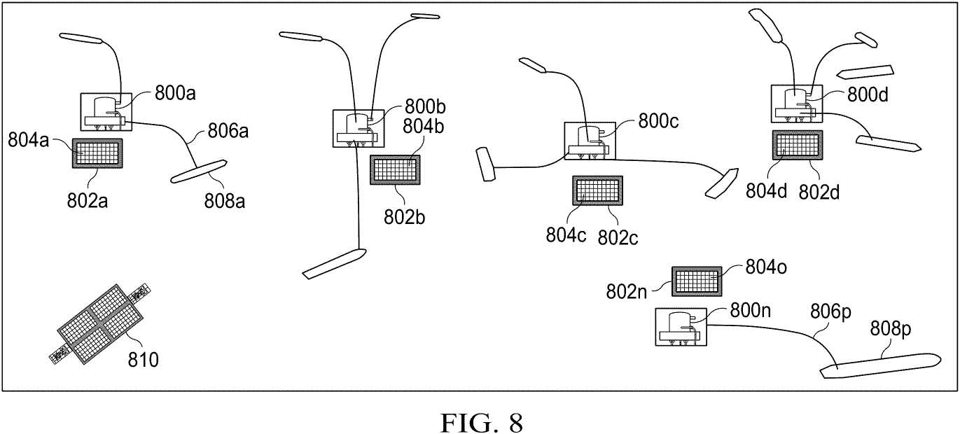

With regard to FIG. 8, an illustration of a set of illustrative charging buoys 800a-800n (collectively 800) that may be connected to respective electrical power systems 802a-802n, such as electrical power systems positioned on marine platforms, barges, vessels, or otherwise, inclusive of flywheels 804a-804o (collectively 804) via respective electrical conductors 806a-806p (collectively 806) and other electrical conductors that may be simultaneously connected to multiple marine vessels and/or other system 808a-808p (collectively 808) that use electrical power for powering electrical systems or recharging rechargeable batteries thereon is shown. A variety of power sources for charging the flywheels 804 on the respective barges and/or platforms 802 may be utilized, as previously described. The flywheels 804 that may be positioned on marine platforms, barges, or vessels may range in storing kinetic energy equivalent to electrical energy between 50 MWh and 500MWh, which means that the flywheels 804 may be capable of charging many vessels simultaneously in parallel or in series. And, because the electrical power systems 802 may be configured with electrical switches to switch electrical power to and from the flywheels to recharge and discharge the flywheels, where discharging the flywheels is performed when supplying electrical power to electrical equipment systems of marine vessels, for example. As shown, an autonomous marine vessel 810 may include one or more electrical power system with fully charged flywheels to replace existing electrical power system(s) 802 that have been drained of kinetic energy naturally or through usage. The autonomous marine vessel 810 may automatically or via remote control by an operator propel the electrical power system(s) and perform an automatic, semi-automatic, or manual replacement, including disconnecting and connecting the electrical conductor(s) 806 to which the existing electrical power system(s) are connected.

The flywheels 804 provide high system efficiency, often greater than 98%. Operational longevity of flywheels may be quite extensive, often extending over 25 years. Power performance is adaptable in that the flywheels 804 may be operated at different speeds to produce different amounts of electrical energy. Moreover, because the flywheels 804 are able to output electricity directly, low power loss results. The flywheels 804 are non-hazardous in that flywheels 804 do not contain hazardous material, thereby being environmentally friendly in the event of a crash, capsizing, or other catastrophic incident. The flywheels 804 are capable of over 1 million cycles, thereby providing an excellent cost value. And, because the flywheels 804 can be charged very fast, recharging time is short and environmentally friendly. Flywheels 804 are also relatively unaffected by outside temperature as the flywheels 804 may be water cooled by a main cooling system of the marine vessel, thereby supporting operations in a wide range of environmental conditions and geographic latitudes.

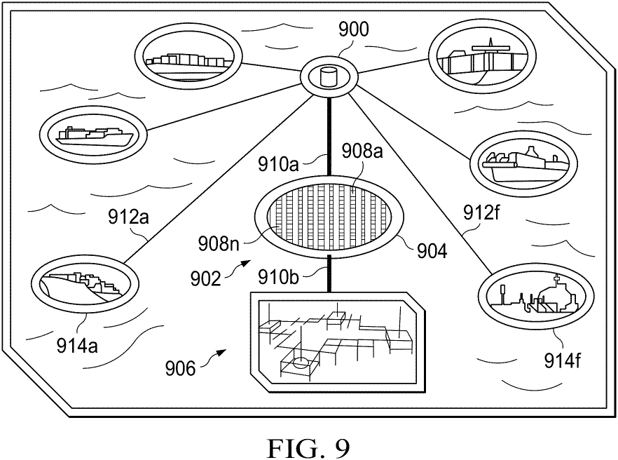

With regard to FIG. 9, an illustration of an illustrative charging buoy 900 that may be connected to an electrical power system 902, such as on a marine platform 904, subsea generator 906, and/or land generator (not shown), inclusive of flywheels 908a-908n via electrical conductors 910a-910b. Multiple electrical conductors 912a-912f may be simultaneously connected to marine vessels or other systems 914a-914f that use electrical power for powering electrical equipment or recharging rechargeable batteries thereon is shown.

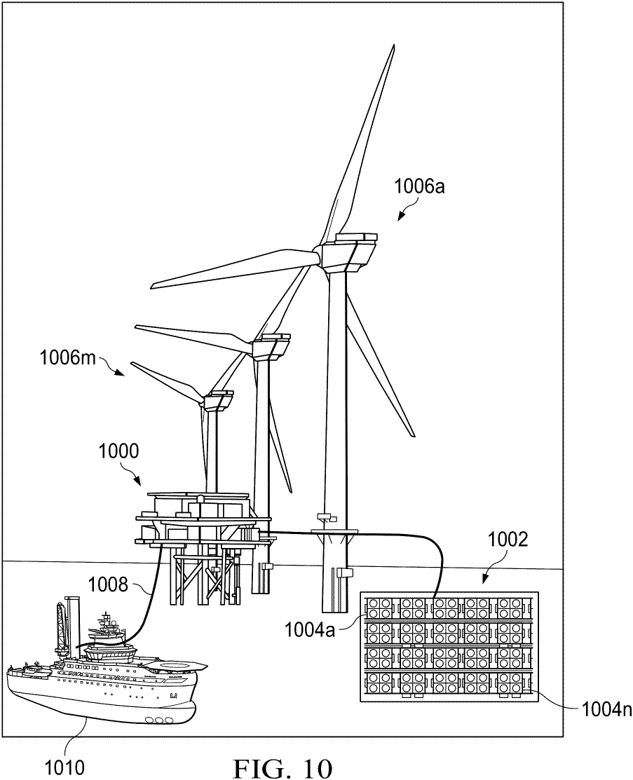

With regard to FIG. 10, an illustration of an illustrative charging station 1000 inclusive of an electrical power system 1002 with integrated flywheels 1004a-1004n (collectively 1004) that may be electrically connected to offshore windmill(s) 1006a-1006m (collectively 1006) to maintain kinetic energy in the flywheels 1004, where the charging station 1000 may include electrical conductor(s) 1008 to recharge rechargeable batteries or flywheels or power electrical equipment on the marine vessels 1010, thereby providing an “all green” solution is shown. Other “green” energy solutions for collecting electrical energy to recharge the flywheels 1004 may be provided

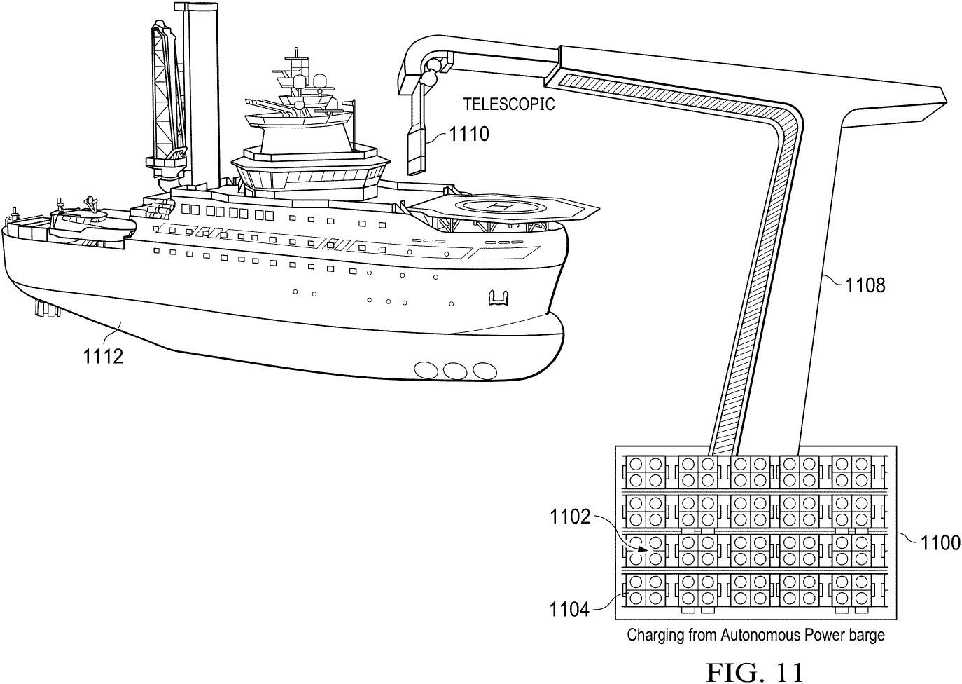

With regard to FIG. 11, an illustration of an illustrative autonomous power station barge 1100 inclusive of an electrical power system 1102 with integrated flywheels 1104 that may be electrically connected to a marine vessel with a flywheel to charge the flywheel within 10 minutes is shown. The autonomous power station barge 1100 may be configured to sail with a limited crew or be independent of onboard operators, but may be monitored by remote control and be controlled remotely in the event of any problems. Operations of the electrical power system may also be controlled autonomously and/or remotely. If autonomous, GPS and/or other navigational systems may be used in conjunction with a dynamic positioning navigation system to automatically control the autonomous power station barge to the destination. If the power station barge 1100 is controlled by electric thrusters, the system may provide for 100% zero emissions. As shown, the power station barge 1100 may be electrically connected to a telescoping charging arm 1108 that includes an electrical conductor 1110 that may be lowered to a connector (not shown), such as an inductive connector that inductively couples to an inductive connector on the electrical conductor 1110, on a marine vessel 1112 for supplying electrical power to electrical equipment and rechargeable power supplies (e.g., batteries and/or flywheels).

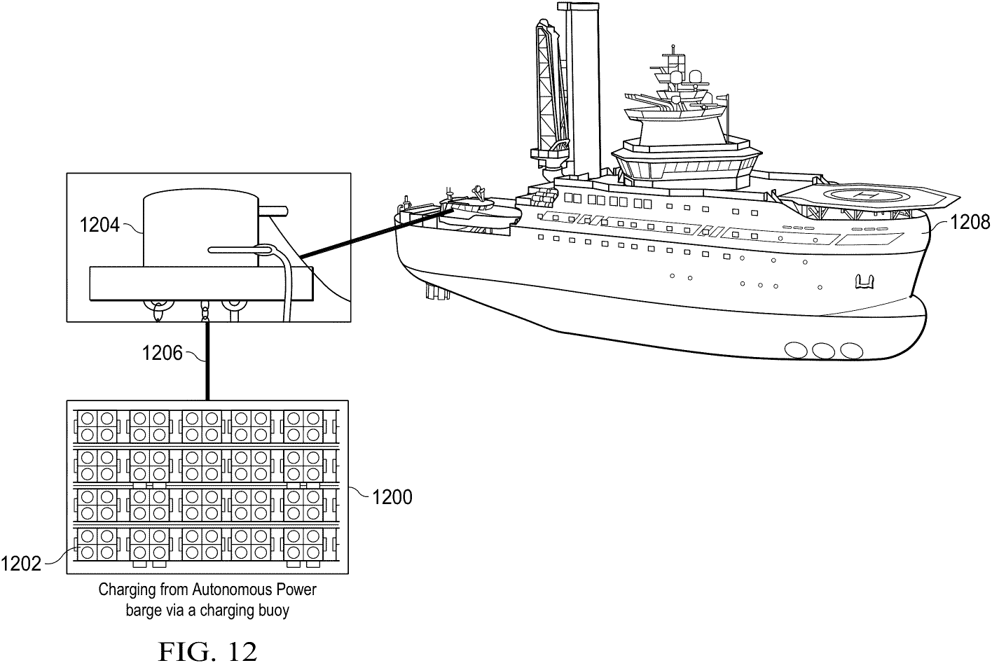

With regard to FIG. 12, an illustration of an illustrative autonomous power station barge 1200 inclusive of an electrical power system with integrated flywheels 1202 that may be electrically connected to a charging buoy 1204 via an electrical conductor 1206 for supplying electrical power to one or more marine vessels 1208 with flywheel(s) to charge the flywheel(s) within 10 minutes is shown. An electrical conductor 1208 may electrically connect the marine vessel 1208 to the charging buoy 1204 to receive electrical power being provided by the flywheels 1202 of the power station barge 1200.

One embodiment of an offshore electrical charging system may include a marine vessel. Multiple flywheels may be stored on the marine vessel. An electrical power network or system may be positioned on the marine vessel, and be electrically connected to the flywheels. An electrical connector may be in electrical communication with the electrical power network to enable electrical power from the flywheels to flow via the electrical connector to supply power from the marine vessel. At least one power switch may be disposed on the electrical power network, and be configured to enable electricity to flow between the electrical connector and flywheels. A controller may be configured to control the at least one power switch to enable and disable electrical power to flow between the flywheels and the electrical connector via the electrical power network.

The system may further include a charging buoy configured to be moored and to supply electrical power via one or more first electrical conductors engaged therewith. At least one second electrical conductor may be electrically connected to the one or more first electrical conductors, and each of the second electrical conductor(s) may be configured to be connected to the electrical connector, such that when electrical power flows via the one or more first electrical conductors to the second electrical conductor(s), electricity is able to be supplied by the electrical power network to an electrical system external from the marine vessel.

One or more electrical power meters may be configured to measure electrical power distributed to a second marine vessel electrically connected to the one or more first electrical conductors. A processor may be configured to receive data from the one and more electrical power meters to determine an amount of power delivered to the second marine vessel to determine amount to invoice an owner or operator of the second marine vessel for recharging services.

At least one timer may be configured to measure an amount of time that a second marine vessel is electrically connected to the one or more first electrical conductors. A processor may be configured to receive data from at least one timer to determine an amount of time that the second marine vessel is electrically connected to the electrical power network, and to determine amount to invoice and owner or operator of the second marine vessel for recharging services.

The system may further include a floating power station including at least one of a wind turbine and solar panel electrically connected to an electrical conductor that connects to the electrical power network for recharging the flywheels. A second marine vessel including the same electrical power components as the marine vessel may be provided.

A computing system may be configured to remotely monitor available charge of the flywheels on the marine vessel and second marine vessel, and determine when to dispatch the second marine vessel with charged flywheels to replace the marine vessel with charge-depleted flywheels. In an embodiment, the marine vessel and second marine vessel may be autonomous marine vessels or moved by autonomous marine vessels.

Multiple first electrical conductors may be electrically connected to an electrical power network located offshore to enable one of more marine vessels to electrically connect thereto to receive electrical power therefrom. A controller configured to (i) enable the marine vessel and second marine vessel to connect, and (ii) cause electrical power to flow from the flywheels of the marine vessel to the electrical power network without disrupting available electrical power being supplied by the electrical power network.

The electrical connector may be an inductive electrical connector. The marine vessel may be a barge. It should be understood that the principles described herein may be applied to a marine platform. Towboats may be configured to move the barges to and from a charging buoy positioned offshore. A second electrical connector configured to enable electricity to flow from the electrical connector and second electrical connector. One or more process for performing the functionality with the system described hereinabove may be provided to support an operator of the marine vessels, platforms, etc.

The foregoing method descriptions and the process flow diagrams are provided merely as illustrative examples and are not intended to require or imply that the steps of the various embodiments must be performed in the order presented. As will be appreciated by one of skill in the art, the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to and/or in communication with another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

What is claimed is:

1. An offshore electrical charging system, comprising:
a marine vessel;
a plurality of flywheels stored on the marine vessel;
an electrical power network on the marine vessel, and electrically connected to flywheels;
an electrical connector in electrical communication with the electrical power network to enable electrical power from the flywheels to flow via the electrical connector to supply power from the marine vessel;
at least one power switch disposed on the electrical power network, and configured to enable electricity to flow between the electrical connector and flywheels; and
a controller configured to control the at least one power switch to enable and disable electrical power to flow between the flywheels and the electrical connector via the electrical power network.

2. The system according to claim 1, further comprising:
a charging buoy configured to be moored and to supply electrical power via one or more first electrical conductors engaged therewith; and
at least one second electrical conductor electrically connected to the one or more first electrical conductors, and each of the at least one second electrical conductors configured to be connected to the electrical connector, such that when electrical power flows via the one or more first electrical conductors to the at least one second electrical conductor, electricity is able to be supplied by the electrical power network to an electrical system external from the marine vessel.

3. The system according to claim 1, further comprising:
one or more electrical power meters configured to measure electrical power distributed to a second marine vessel electrically connected to the one or more first electrical conductors; and
a processor configured to receive data from the one and more electrical power meters to determine an amount of power delivered to the second marine vessel to determine amount to invoice an owner or operator of the second marine vessel for recharging services.

4. The system according to claim 1, further comprising:
at least one timer configured to measure an amount of time that a second marine vessel is electrically connected to the one or more first electrical conductors; and
a processor configured to receive data from at least one timer to determine an amount of time that the second marine vessel is electrically connected to the electrical power network, and to determine amount to invoice and owner or operator of the second marine vessel for recharging services.

5. The system according to claim 1, further comprising a floating power station including at least one of a wind turbine and solar panel electrically connected to an electrical conductor that connects to the electrical power network for recharging the flywheels.

6. The system according to claim 1, further comprising a second marine vessel including the same electrical power components as the marine vessel.

7. The system according to claim 6, further comprising a computing system configured to:
remotely monitor available charge of the flywheels on the marine vessel and second marine vessel; and
determine when to dispatch the second marine vessel with charged flywheels to replace the marine vessel with charge-depleted flywheels.

8. The system according to claim 6, wherein the marine vessel and second marine vessel are autonomous marine vessels or moved by autonomous marine vessels.

9. The system according to claim 6, further comprising:
a plurality of first electrical conductors electrically connected to an electrical power network located offshore to enable one of more marine vessels to electrically connect thereto to receive electrical power therefrom;
a controller configured to (i) enable the marine vessel and second marine vessel to connect, and (ii) cause electrical power to flow from the flywheels of the marine vessel to the electrical power network without disrupting available electrical power being supplied by the electrical power network.

10. The system according to claim 1, wherein the electrical connector is an inductive electrical connector.

11. The system according to claim 1, wherein the marine vessel is a barge.

12. The system according to claim 11, further comprising towboats configured to move the barges to and from a charging buoy positioned offshore.

13. The system according to claim 11, further comprising a second electrical connector configured to enable electricity to flow from the electrical connector and second electrical connector.
